(19) United States
(12) Patent Application Publication
(10) Pub. No.: US 2025/0185651 A1
(43) Pub. Date: Jun. 12, 2025

(54) COMPOSITION FOR PESTICIDE PHYTOTOXICITY REDUCTION COMPRISING AMINO ACID

(71) Applicant: CJ CheilJedang Corporation, Seoul (KR)

(72) Inventors: Gyuree KIM, Seoul (KR); Ju Yeon SON, Seoul (KR); Youngjoo OH, Seoul (KR); Yuna KANG, Seoul (KR); Victor Dalla COSTA, Piracicaba (BR); Guilherme Soriani ALMEIDA, Piracicaba (BR)

(73) Assignee: CJ CheilJedang Corporation, Seoul (KR)

(21) Appl. No.: 18/294,847

(22) PCT Filed: Aug. 5, 2022
(86) PCT No.: PCT/KR2022/011683

§ 371 Date: Feb. 2, 2024

(30) Foreign Application Priority Data
Aug. 6, 2021 (KR) 10-2021-0103705
Jan. 7, 2022 (KR) 10-2022-0002693

(51) Int. Cl. A01N 25/32; A01N 43/78; A01P 5/00

(52) U.S. Cl. CPC A01N 25/32; A01N 43/78; A01P 5/00

(57) ABSTRACT

The present application relates to an amino acid effective in reducing plant phytotoxicity caused by a pesticide, and to uses thereof. When treating the amino acid alone or an amino acid combination together with the pesticide, phytotoxicity, which may occur when the pesticide is treated on seeds or is directly sprayed thereon, is reduced such that plants can normally develop.

### CROSS-REFERENCE TO RELATED APPLICATION(S)

The present application claims the benefit of the priority based on Korean Patent Application No. 10-2021-0103705 filed on Aug. 6, 2021 and Korean Patent Application No. 10-2022-0002693 filed on Jan. 7, 2022, and the entire contents disclosed in the documents of the corresponding Korean patent applications are incorporated as a part of the present description.

The present application relates to an amino acid having efficacy for pesticide phytotoxicity reduction and a use thereof.

### TECHNICAL FIELD

### Background Art

Seed treatment has an effect of preventing disease and insect pest and itis used on the stage of sowing seeds. Since it requires a smaller amount of pesticides than foliar treatment by spraying, it helps to save spraying time and cost. And it is also helpful for preventing environmental pollution. However, depending on an active ingredient of a drug, phytotoxicity such as drying or yellowing of leaves of plants may occur. And it may occur regardless of the treatment method depending on the treatment concentration or condition.

Accordingly, amino acids that are effective in reducing pesticide phytotoxicity by increasing a defense mechanism of plants have been newly selected.

### PRIOR ART

### Patent Document

(Patent document 1) U.S. Pat. No. 8,318,635 B2

### DISCLOSURE

### Technical Problem

An object of the present application is to provide a composition for reducing phytotoxicity by a pesticide comprising an amino acid as an active ingredient.

Another object of the present application is to provide a pesticide composition comprising a pesticide and an amino acid.

Other object of the present application is to provide a fertilizer composition comprising an amino acid as an active ingredient.

Other object of the present application is to provide a method for cultivating a plant or a method for reducing phytotoxicity of a plant by a pesticide, comprising a step of treating an amino acid to a plant.

Other object of the present application is to provide a use of the amino acid for using in reducing phytotoxicity by a pesticide.

Other object of the present application is to provide a use of the amino acid for using in manufacture of a composition for reducing phytotoxicity by a pesticide.

### Technical Solution

This will be described in detail as follows. On the other hand, each description and embodiment disclosed in the present application may be applied to each other description and embodiment. In other words, all combinations of various elements disclosed in the present application fall within the scope of the present application. In addition, it cannot be seen that the scope of the present application is limited by the detailed description described below. Furthermore, those skilled in the art can recognize or confirm many equivalents to specific aspects of the present application described in the present application using only a common experiment. In addition, these equivalents are intended to be included in the present application.

Hereinafter, the present application will be described in more detail.

### Amino Acids

The amino acids provided herein may be at least one amino acid selected from the group consisting of histidine, glutamic acid, valine, isoleucine, leucine, aspartic acid, serine, asparagine, glutamine, cysteine, glycine, proline, alanine, phenylalanine and tyrosine or a salt thereof.

In the present description, when the term “amino acid” is used alone, this may be used as meaning both an amino acid or a salt of the amino acid. In addition, the amino acid or salt thereof may be described as “amino acids”.

Herein, a salt of an amino acid may mean a physiologically acceptable salt among salts which are substances in which a cation and an anion are combined by electrostatic attraction, and for example, may mean an agrochemically acceptable salt and/or a salt applicable for plant cultivation. For example, the salt may be at least one selected from the group consisting of metal salts, salts with organic bases, salts with inorganic bases, salts with organic acids and the like. In one embodiment, the metal salt may be at least one selected from the group consisting of alkali metal salts (sodium salt, potassium salt, etc.), alkali earth metal salts (calcium salt, magnesium salt, barium salt, etc.), aluminum salts and the like; and the salt with organic bases may be at least one selected from the group consisting of salts with triethylamine, pyridine, picoline, 2,6-lutidine, ethanolamine, diethanolamine, triethanolamine, cyclohexylamine, dicyclohexylamine, N,N-dibenzylethylenediamine, and the like; and the salts with inorganic acids may be at least one selected from the group consisting of hydrochloric acid, hydrobromic acid, nitric acid, sulfuric acid, phosphoric acid and the like; and the salt with organic acids may be at least one selected from the group consisting of salts with formic acid, acetic acid, trifluoroacetic acid, phthalic acid, fumaric acid, oxalic acid, tartaric acid, maleic acid, citric acid, succinic acid, methane sulfonic acid, benzene sulfonic acid, p-toluene sulfonic acid, and the like.

In one embodiment, the salt of histidine may be hydrochloride of histidine (His-HCl), and the salt of glutamic acid may be a sodium salt of glutamic acid (sodium glutamate, MSG, monosodium glutamate).

In one embodiment, the amino acid may be
at least one (for example, one or more kinds, 2 or more kinds, 3 or more kinds, or 4 or more kinds, or one kind, 2 kinds, 3 kinds, 4 kinds or 5 kinds) amino acid selected from the group consisting of histidine, glutamic acid, valine, isoleucine and leucine or a salt thereof.

In one embodiment, the amino acid may be
histidine, hydrochloride of histidine, glutamic acid, sodium glutamate, valine or leucine.

In one embodiment, the amino acid may be
a combination of histidine and glutamic acid, a combination of histidine and sodium glutamate, a combination of hydrochloride of histidine and glutamic acid, a combination of hydrochloride of histidine and sodium glutamate, a combination of valine and histidine, a combination of valine and hydrochloride of histidine, a combination of leucine and histidine, a combination of leucine and hydrochloride of histidine, a combination of valine and glutamic acid, a combination of valine and sodium glutamate, a combination of leucine and glutamic acid, a combination of leucine and sodium glutamate, or a combination of valine and leucine.

In one embodiment, when 2 kinds of amino acids among the amino acids or salts thereof are used in combination, the ratio of each amino acid (combination ratio of amino acids) may be 1:9 to 0.111 (or, 1:9 to 9:1), 1:8 to 0.125, 1:7 to 0.143 (or, 1:7 to 7:1), 1:6 to 0.167 (or, 1:6 to 6:1), 1:5 to 0.2, 1:4 to 0.25, 1:3 to 0.333 (or, 1:3 to 3:1), 1:2 to 0.5, or 1:1, based on the weight of each amino acid, but not limited thereto.

When the amino acid is used in a form of a salt of an amino acid, the weight of the amino acid may be 10 to 95% (w/v), 10 to 90% (w/v), 10 to 86% (w/v), 10 to 80% (w/v), 60 to 95% (w/v), 60 to 90% (w/v), 60 to 86% (w/v), 60 to 80% (w/v), 70 to 95% (w/v), 70 to 90% (w/v), 70 to 86% (w/v), 70 to 80% (w/v), 80 to 95% (w/v), 80 to 90% (w/v), 80 to 86% (w/v), or 86% (w/w) based on the weight of the salt of the amino acid, but not limited thereto.

### Composition and Method

One aspect provides a composition for reducing phytotoxicity by a pesticide comprising the amino acid or salt thereof as an active ingredient, by confirming that the amino acid or salt thereof has the efficacy of reducing damage (for example, phytotoxicity, etc.) of a plant by a pesticide.

Another aspect provides a use for using in reducing phytotoxicity by a pesticide of the amino acid or salt thereof.

Other aspect provides a use for using in preparation of a composition for reducing phytotoxicity by a pesticide of the amino acid or salt thereof.

The amino acid or salt thereof may be usefully used for reducing phytotoxicity by a pesticide.

In the present description, the term “plant” refers to all physical parts of a plant, including at least one site selected from the group consisting of seeds, seedlings, saplings, roots, tubers, stems, zones, foliage and fruits.

In the present description, the term “composition for reducing phytotoxicity” may mean a substance which reduces an undesired effect of a pesticide against a non-target organism, when used in combination with a pesticide, and for example, the composition for reducing phytotoxicity may protect plants from damage by a pesticide, but not protect the effect of the pesticide (for example, killing nematodes).

In the present description, the term “phytotoxicity” may mean damage appearing to a plant as a side effect of spraying a pesticide, and the like. When a pesticide is sprayed to a plant, it may have several influences on sclerophylls (stems and leaves), roots, flowers, fruits, and the like of the plant. Symptoms appearing on the sclerophylls include leaf discoloration (yellowing phenomena such as whitening, chlorosis, and the like, or discoloration to brown, light gray, yellowish brown, dark brown, and the like when a part of a living body is necrotic), leaf malformation, fallen leaves, and the like. Symptoms appearing at roots include rooting inhibition, deformity, browning, hypertrophy inhibition, root length and weight reduction, and the like. Symptoms appearing at flowers include flowering delay, deciduous fruit trees, leaf burning, darkening and the like. Symptoms appearing to fruits include fruit drop, malformation, leaf burning, pigmentation, fertility disorders and the like.

The pesticide may have a sterilization effect on nematodes (for example, nematicides). A nematode (round worm) is a trigeminal animal belonging to the phylum of linear animals, and is known to be largely divided into Secernentea and Adenophora. Animals belonging to the nematode include heartworm (Irofilaria immitis), Caenorhabditis elegans, Root-knot nematode (Meloidogyne ssp.), Trichostrongylus, Tylenchulus semipenetrans, Pratylenchus spp., Aphelenchoides spp., Cyst Nematode, H. imamuri, or Bursaphelenchus xylophilus, and the like. The amino acid of the present application may exhibit efficacy of reducing damage by a pesticide against any pesticide that has a sterilization effect on nematodes, and in one embodiment, the pesticide (for example, nematicide) may be at least one selected from the group consisting of aldoxycarb, fosthietan, oxamyl, fenamiphos, Fosthiazate (or fosthiazate), Fluensulfone, Ethoprophos, Dazomet, Carbosulfan, Cadusafos, Methyl bromide, Benfuracarb, and Abamectin, and the like.

The composition for reducing phytotoxicity of the present application may be a preparation having various kinds of formulations such as dustable powder, a granule, wettable powder, water soluble powder, a water dispersible granule, a water soluble granule, suspo-emulsion (Suspension concentrate, Emulsion oil in water, Flowable), emulsifiable concentrate, and the like. In formulation, known additives, carriers and the like may be used. For formulation, the amino acid or salt thereof of the present application, and a pesticide component are formulated separately and then mixed, and the amino acid or salt thereof of the present application, and a pesticide component are mixed and then formulated. When formulating separately, preparations in the same form may be prepared and mixed, and then, may be used by diluting with water or the like, and may be used by diluting with water and the like and then mixing, and may be sprayed separately without mixing after diluting with water and the like, and when sprayed separately, they may be sprayed at the same time, and may be sprayed either one first and the other after that.

The solution used for “diluting with water and the like” is not particularly limited as long as it is to make easy to dilute and spray a phytotoxicity reducing agent, a composition for reducing phytotoxicity, a pesticide component, a formulated phytotoxicity reducing agent, a formulated composition for reducing phytotoxicity, or a formulated pesticide component, or the like, but tap water, industrial water, well water, river water, groundwater, and the like may be illustrated. In addition, it may also be simply called “water for dilution”.

Additives for formulation are not particularly limited, and additives commonly used in pesticide formulations may be used. For example, in case of suspo-emulsion, water, an antifoaming agent and the like may be added, and in case of emulsifiable concentrate, an organic solvent (oil solvent) and the like may be added, and in case of the water dispersible granule or water soluble granule, water which is contained during granule preparation and then removed by drying, and the like may be added.

A carrier may be contained for preparation of powder, granules, wettable powder and the like. The carrier is not particularly limited, and carriers commonly used for pesticide formulations may be used. As the carrier, calcium carbonate, calcium sulfate, ammonium sulfate, potassium sulfate, sodium sulfate, sodium benzoate, silicon dioxide, diatomite, apatite, talc, bentonite, pyrophyllite, clay, joint soil and the like may be illustrated.

Other aspect provides a pesticide composition comprising the amino acid or salt thereof; and a pesticide.

The amino acid of the present application may exhibit efficacy for reducing damage by a pesticide, so it is possible to reduce damage by a pesticide while obtaining an effect of preventing or improving damage of plants caused by nematodes by using it together with a pesticide.

The amino acid and pesticide are as described above.

When a pesticide composition comprising the amino acid according to one embodiment is used for plants, compared to the case of using a pesticide composition comprising no amino acid, the phototoxicity may be reduced.

Other aspect provides a fertilizer composition comprising the amino acid or salt thereof.

In the present description, the term “fertilizer” may mean a substance that causes chemical changes in soil to help cultivation of plants, a substance that nourishes plants, and the like. The fertilizer may comprise at least one (for example, one or more kinds, 2 or more kinds, 3 or more kinds, or one kind, 2 kinds, 3 kinds or 4 kinds) selected from the group consisting of nitrogen, phosphorus, potassium and calcium, but not limited thereto. The fertilizer may be classified into an organic fertilizer or an inorganic fertilizer. The organic fertilizer may be a vegetable fertilizer or an animal fertilizer. The vegetable fertilizer may be compost, manure, oil cake such as sesame cake, rice bran, humus and the like, and the animal fertilizer may be silkworm pupa meal, bone meal, meat meal, carcass, excreta and the like. The inorganic fertilizer may be a single fertilizer or a composite fertilizer. The single fertilizer may include nitrogenous fertilizers (including urea, ammonium sulfate, ammonium nitrate, ammonium chloride and/or lime nitrogen, etc.), phosphoric fertilizers (including superphosphate lime (single superphosphate), polysuperphosphate lime (triple superphosphate), fused phosphate, and/or fused superphosphate, etc.), potassium fertilizers (including potassium chloride and/or potassium sulfate, etc.), calcareous (calcium) fertilizers (including lime, slacked lime and/or carbonated lime, etc.), siliceous fertilizers (including calcium silicate, etc.) and the like. The composite fertilizer may be a fertilizer comprising at least two or more components selected from the group consisting of nitrogen, phosphorus, potassium, silicic acid and the like.

The fertilizer may further comprise an inorganic element such as sulfur, calcium, magnesia, boron, copper, zinc, manganese, iron, molybdenum, and the like.

The fertilizer may be formulated and used in various formulations such as a powder formulation, a granular formulation and the like. In the formulation, known additives, carriers and the like may be used.

The amino acid of the present application may exhibit efficacy for reducing damage by a pesticide, so it can reduce damage by a pesticide, even if a fertilizer is applied to plants and a pesticide is used.

The amino acid and pesticide are as described above.

Other aspect provides a method for cultivation of a plant, comprising treating the amino acid or salt thereof, or the composition (composition for reducing phytotoxicity by a pesticide, pesticide composition or fertilizer composition). The method may further comprise treating a pesticide to the plant, before, after or simultaneously with the treating the amino acid or composition. The method may be characterized by reducing phytotoxicity of a plant by a pesticide.

Other aspect provides a method for reducing phytotoxicity of a plant by a pesticide, comprising treating the amino acid or the composition (composition for reducing phytotoxicity by a pesticide, pesticide composition or fertilizer composition) to a plant.

The amino acid, composition and pesticide are as described above.

It may be conducted by diluting the composition and/or pesticide component to a predetermined concentration using water. A trial of the composition for reducing phytotoxicity and/or pesticide component may be performed by what formulating the composition for reducing phytotoxicity and/or pesticide component. In addition, depending on the formulation, it may be conducted by a method such as scattering, spraying, mixing, irrigation and the like.

The concentration of the amino acid or salt thereof in the composition (for example, composition for reducing phytotoxicity or pesticide composition) provided in the present description may be 0.001 to 1% (w/v), 0.001 to 0.75% (w/v), 0.001 to 0.5% (w/v), 0.001 to 0.25% (w/v), 0.001 to 0.1% (w/v), 0.001 to 0.075% (w/v), 0.001 to 0.05% (w/v), 0.001 to 0.025% (w/v), 0.001 to 0.01% (w/v), 0.001 to 0.0075% (w/v), 0.001 to 0.005% (w/v), 0.001 to 0.0025% (w/v), 0.0025 to 1% (w/v), 0.0025 to 0.75% (w/V), 0.0025 to 0.5% (w/v), 0.0025 to 0.25% (w/v), 0.0025 to 0.1% (w/v), 0.0025 to 0.075% (w/v), 0.0025 to 0.05% (w/v), 0.0025 to 0.025% (w/v), 0.0025 to 0.01% (w/V), 0.0025 to 0.0075% (w/v), 0.0025 to 0.005% (w/v), 0.005 to 1% (w/v), 0.005 to 0.75% (w/v), 0.005 to 0.5% (w/v), 0.005 to 0.25% (w/v), 0.005 to 0.1% (w/v), 0.005 to 0.075% (w/v), 0.005 to 0.05% (w/v), 0.005 to 0.025% (w/v), 0.005 to 0.01% (w/v), 0.005 to 0.0075% (w/v), 0.0075 to 1% (w/v), 0.0075 to 0.75% (w/v), 0.0075 to 0.5% (w/V), 0.0075 to 0.25% (w/v), 0.0075 to 0.1% (w/v), 0.0075 to 0.075% (w/v), 0.0075 to 0.05% (w/v), 0.0075 to 0.025% (w/v), 0.0075 to 0.01% (w/v), 0.01 to 1% (w/v), 0.01 to 0.75% (w/v), 0.01 to 0.5% (w/v), 0.01 to 0.25% (w/v), 0.01 to 0.1% (w/v), 0.01 to 0.075% (w/v), 0.01 to 0.05% (w/v), 0.01 to 0.025% (w/v), 0.025 to 1% (w/v), 0.025 to 0.75% (w/v), 0.025 to 0.5% (w/v), 0.025 to 0.25% (w/v), 0.025 to 0.1% (w/v), 0.025 to 0.075% (w/v), 0.025 to 0.05% (w/v), 0.05 to 1% (w/v), 0.05 to 0.75% (w/v), 0.05 to 0.5% (w/v), 0.05 to 0.25% (w/v), 0.05 to 0.1% (w/v), 0.05 to 0.075% (w/v), 0.075 to 1% (w/v), 0.075 to 0.75% (w/v), 0.075 to 0.5% (w/v), 0.075 to 0.25% (w/v), 0.075 to 0.1% (w/v), 0.1 to 1% (w/v), 0.1 to 0.75% (w/v), 0.1 to 0.5% (w/v), 0.1 to 0.25% (w/v), 0.25 to 1% (w/v), 0.25 to 0.75% (w/v), 0.25 to 0.5% (w/v), 0.5 to 1% (w/v), 0.5 to 0.75% (w/V), or 0.75 to 1% (w/v), based on the weight (g) of the amino acid or salt thereof compared to the volume (ml) of the composition, but not limited thereto.

The weight (g) of the amino acid or salt thereof in the composition (for example, pesticide composition) provided in the present description may be 0.001 to 100 times, 0.001 to 10 times, 0.001 to 1 time, 0.001 to 0.1 time, 0.001 to 0.01 time, 0.01 to 100 times, 0.01 to 10 times, 0.01 to 1 time, 0.01 to 0.1 time, 0.1 to 100 times, 0.1 to 10 times, 0.1 to 1 time, 1 to 100 times, 1 to 10 times, or 10 to 100 times, based on the weight (g) of the pesticide in the composition, but not limited thereto.

The weight (g) of the amino acid or salt thereof in the composition (for example, composition for reducing phytotoxicity, pesticide composition or fertilizer composition) provided in the present description may be 0.00001 to 1 time, 0.00001 to 0.1 time, 0.00001 to 0.01 time, 0.00001 to 0.001 time, 0.00001 to 0.0001 time, 0.0001 to 1 time, 0.0001 to 0.1 time, 0.0001 to 0.01 time, 0.0001 to 0.001 time, 0.001 to 1 time, 0.001 to 0.1 time, 0.001 to 0.01 time, 0.01 to 1 time, 0.01 to 0.1 time, or 0.1 to 1 time, based on the weight (g) of the plant to which the present composition is applied, but not limited thereto.

The applicable plant of the composition (for example, composition for reducing phytotoxicity, pesticide composition or fertilizer composition) and/or method provided in the present description is not particularly limited, and may be selected from prokaryotic plants (for example, algae, etc.) and eukaryotic plants. In one embodiment, the plant may be at least one selected from plant of family fabaceae, plant of family fabaceae, genus Glycine (for example, Glycine max), plant of family fabaceae, genus Arachis (for example, Arachis hypogaea), plant of family poaceae, plant of family poaceae, genus Saccharum (for example, sugar cane, Saccharum officinarum), plant of family poaceae, genus Triticum (for example, Triticum aestivum), plant of family poaceae, genus Sorghum (for example, Sorghum bicolor), plant of family malvaceae, plant of family malvaceae, genus Gossypium (for example, cotton plant, Gossypium indicum), plant of family solanaceae, plant of family solanaceae, genus Solanum (for example, potato, tomato (Solanum lycopersicum), etc), plant of family rubiaceae, plant of family rubiaceae, genus Coffea (for example, coffee (Coffea arabica)), plant of family Lilium, plant of family Lilium, genus Allium (for example, garlic (Allium sativum)), plant of family vitaceae, plant of family vitaceae, genus Vitis (for example, grape (Vitis vinifera)) and the like, but not limited thereto.

The part of the plant to which the composition (for example, composition for reducing phytotoxicity, pesticide composition or fertilizer composition) and/or method provided in the present description is not particularly limited, and for example, it may be at least one selected from the group consisting of whole plants, seeds, roots, leaves, stems, flowers and the like.

### Advantageous Effects

When the amino acid alone or amino acid combination of the present application was treated with a pesticide, an excellent effect of reducing phytotoxicity that may occur when the pesticide is treated or directly sprayed on a seed so that a plant can develop normally.

### BRIEF DESCRIPTION OF THE DRAWINGS

FIG. 1 is a graph showing the germination rate of soybeans when treated with fluensulfone and an amino acid alone.

FIG. 2 is a graph showing the length of the shoots of soybeans when treated with fluensulfone and an amino acid alone.

FIG. 3 and FIG. 4 show photographs of the shoots and roots of soybeans when treated with fluensulfone and an amino acid alone.

FIG. 5 shows the leaf size of soybeans when treated with fluensulfone and an amino acid alone or a combination of amino acids.

FIG. 6 shows the shoots and roots of soybeans when treated with fluensulfone and an amino acid alone or a combination of amino acids.

FIG. 7 is a graph showing the fresh weight of the soybean shoots when treated with fluensulfone and an amino acid alone or a combination of amino acids.

FIG. 8 shows measurement of the phytotoxicity of soybeans according to the SBCPD scale when treated with fluensulfone and an amino acid alone or a combination of amino acids.

### MODE FOR INVENTION

Hereinafter, the present invention will be described in more detail by the following examples. However, these are intended to illustrate the present invention only, but the scope of the present invention is not limited by these examples.

### Example 1. Selection of Amino Acids with Pesticide Phytotoxicity Reducing Efficacy

To 10 g of seeds of soybeans (scientific name: Glycine max), fluensulfone (Nimitz, ADAMA, 40% (w/v) Fluensulfone-containing product) or fluensulfone with 1 ml of 0.1% (w/v) amino acid solution were treated as a pesticide. Fluensulfone was treated at a ratio of 100 g per 100 kg of seeds (g of active ingredient per 100 kg of seeds). The treatment groups were as Table 1 below.

TABLE 1

| | | Dosage (g of active ingredient |
|---|---|---|
| Treatment | Products | per 100 Kg of seeds) |
| 1 | Control (water) | — |
| 2 | Fluensulfone (F•S) | 100 |
| 3 | Fluensulfone + His | 100 + 0.1% His |
| 4 | Fluensulfone + MSG | 100 + 0.1% MSG |
| 5 | Fluensulfone + Val | 100 + 0.1% Val |
| 6 | Fluensulfone + Ile | 100 + 0.1% Ile |
| 7 | Fluensulfone + Leu | 100 + 0.1% Leu |

* Group 1: Control group (water);
Group 2: Fluensulfone (F•S);
Group 3: Fluensulfone + 0.1%(w/v) histidine (His);
Group 4: Fluensulfone + 0.1%(w/v) monosodium glutamic acid (MSG);
Group 5: Fluensulfone + 0.1%(w/v) valine (Val);
Group 6: Fluensulfone + 0.1%(w/v) isoleucine (Ile);
Group 7: Fluensulfone + 0.1%(w/v) leucine (Leu)

After mixing the solutions of each group well, they were sufficiently mixed for about 1 minute so that the solutions were evenly applied to soybean seeds. After than, they were taken out in a sample dish and air-drying was performed until the solutions were dried.

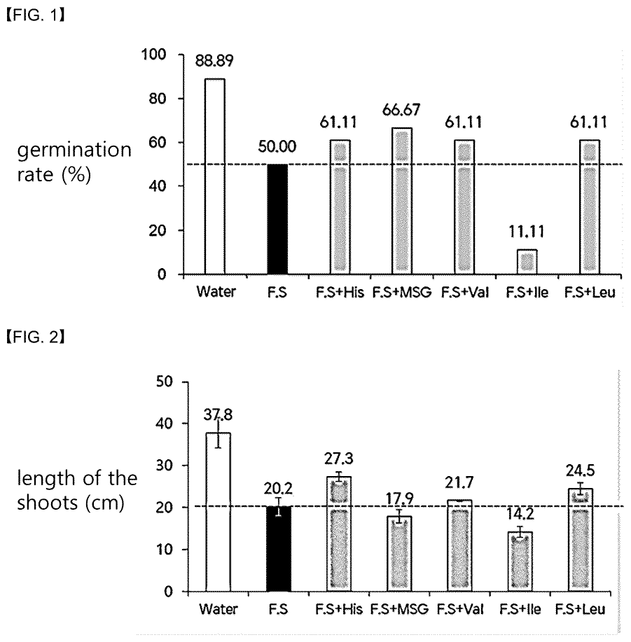

Soybean seeds were sown, and the germination rate was measured by counting the number of germinated seeds among all the seeds in 7 days after sowing, and this was shown in FIG. 1.

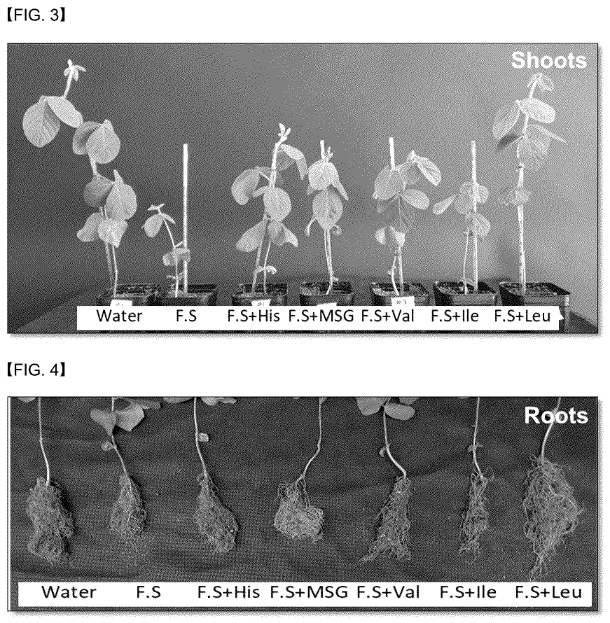

In 20 days after sowing, the length of the shoots (from the ground to the growth point) was measured with a ruler and this was shown in FIG. 2, and the photographs of the shoots and roots were shown in FIG. 3 and FIG. 4.

As shown in FIG. 1, it was confirmed that the germination rate of the amino acid-treated Group 3 (histidine, F.S+His), Group 4 (sodium glutamic acid, F.S+MSG), Group 5 (valine, F.S+Val), Group 7 (leucine, F.S+Leu) was increased, compared to the fluensulfone-treated Group 2 (F.S).

In addition, as in FIG. 2, the stalk length of Group 3 (F.S+His), Group 5 (F.S+Val) and Group 7 (F.S+leu) that were treated fluensulfone with a singleamino acid was measured longer compared to the fluensulfone-treated Group 2. Also growth and development of the shoots and roots of them were increased, compared to the fluensulfone-treated Group 2 as in FIG. 3 and FIG. 4.

From this result, it is confirmed that the phytotoxicity by fluensulfone can be reduced by histidine, sodium glutamic acid and leucine.

### Example 2. Confirmation of Synergistic Effect of Amino Acids with Pesticide Phytotoxicity Reducing Efficacy

Fluensulfone or fluensulfone with 1 ml of 0.01% (w/v) of amino acid solution were treated to 10 g of soybean seeds. Fluensulfone was treated at a ratio of 100 g per 100 kg of seeds. The treatment groups were shown as Table 2 below.

TABLE 2

| | | Dosage (g of active ingredient |
|---|---|---|
| Treatment | Product | per 100 Kg of seeds) |
| 1 | Control (Water) | — |
| 2 | Fluensulfone (F•S•) | 100 |
| 3 | F•S + His | 100 + 0.01% |
| 4 | F•S + MSG | 100 + 0.01% |
| 5 | F•S + Leu | 100 + 0.01% |
| 6 | F•S + Val | 100 + 0.01% |
| 7 | F•S + His + MSG | 100 + 0.01% + 0.01% |
| 8 | F•S + His + Leu | 100 + 0.01% + 0.01% |
| 9 | F•S + His + Val | 100 + 0.01% + 0.01% |
| 10 | F•S + MSG + Leu | 100 + 0.01% + 0.01% |
| 11 | F•S + MSG + Val | 100 + 0.01% + 0.01% |
| 12 | F•S + Leu + Val | 100 + 0.01% + 0.01% |

* Group 1: Control group (water);
Group 2: Fluensulfone (F•S);
Group 3: Fluensulfone + 0.01%(w/v) histidine (Hist);
Group 4: Fluensulfone + 0.01%(w/v) monosodium glutamic acid (MSG);
Group 5: Fluensulfone + 0.01%(w/v) leucine (Leu);
Group 6: Fluensulfone + 0.01%(w/v) valine (Val);
Group 7: Fluensulfone + 0.01%(w/v) histidine + 0.01%(w/v) sodium glutamic acid;
Group 8: Fluensulfone + 0.01%(w/v) histidine + 0.01%(w/v) leucine;
Group 9: Fluensulfone + 0.01%(w/v) histidine + 0.01%(w/v) valine;
Group 10: Fluensulfone + 0.01%(w/v) sodium glutamic acid + 0.01%(w/v) leucine;
Group 11: Fluensulfone + 0.01%(w/v) sodium glutamic acid + 0.01%(w/v) valine;
Group 12: Fluensulfone + 0.01%(w/v) leucine + 0.01%(w/v) valine

After mixing the solutions of each group well, they were sufficiently mixed for about 1 minute so that the solutions were evenly applied to soybean seeds. After than they were taken out in a sample dish and air-drying was performed until the solutions were dried.

Soybean seeds were sown, and in 20 days after sowing, the phytotoxicity was evaluated according to the SBCPD scale as Table 3 below, and this was shown in FIG. 8.
SBCPD scale: method designed by Brazilian weed Science society to evaluate phytotoxicity. Close to 0 means no phytotoxicity-related symptoms, and close to 100 means plant death

TABLE 3

| Grade | Definition |
|---|---|
| 0-5 | Grade 0: when plants are with normal development |
| | Grade 1 to 5: mild symptoms |
| 6-10 | Marked symptom with low intensity |
| 11-20 | Marked symptom with higher intensity than previous grade |
| 21-35 | Most evident symptom, however totally tolerated by plants |
| 36-45 | More drastic symptoms than previous grade, but can be |
| | recovered by plants without yield reduction |
| 46-60 | Irreversible damage, with prevision of yield reduction |
| 61-100 | Very severe irreversible damage, with drastic reduction in |
| | yield |
| | Grade 100 means plants death |

Source: SBCPD (1995)

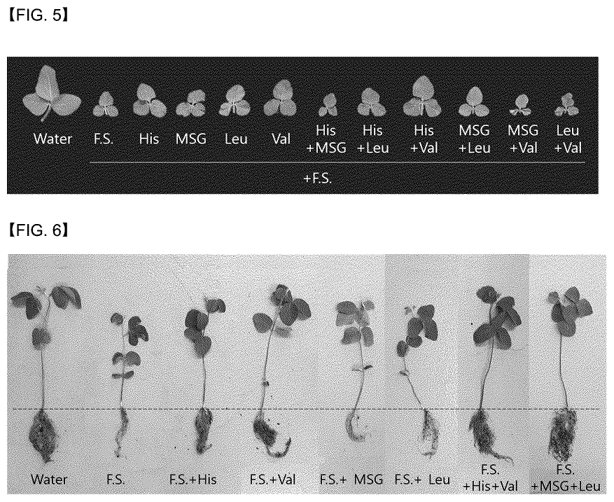

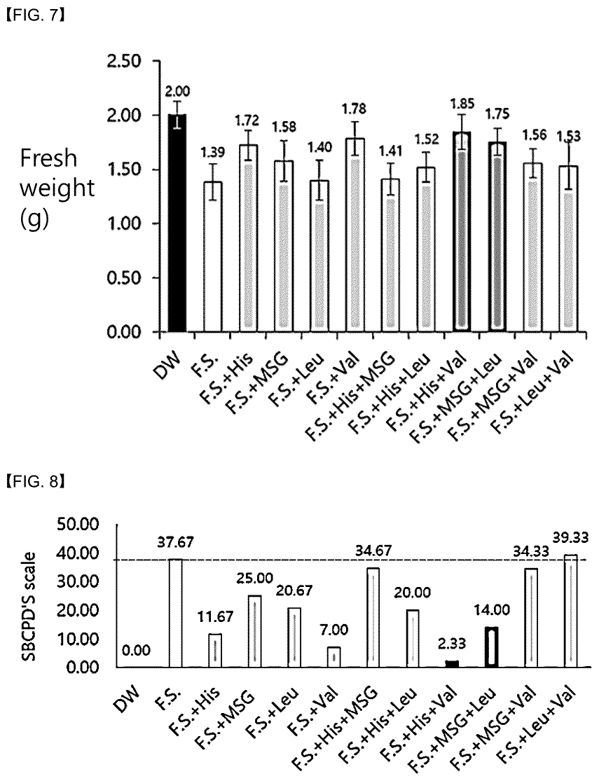

The photographs in 20 days after sowing were shown in FIG. 5 and FIG. 6. The weight (fresh weight) of the shoots was measured with a scale. The average value between groups was calculated, and this was shown as a graph in FIG. 7. As in FIG. 5 and FIG. 6, it was confirmed that the growth and development of the shoots and roots were improved due to the phytotoxicity reducing efficacy, when amino acid was treated alone (Group 3 to Group 6) and a combination of amino acids were treated (Group 7 to Group 12), compared to the fluensulfone-treated Group 2 (F.S).

As in FIG. 7, it was confirmed that the weight (fresh weight) of the shoots was increased due to the phytotoxicity reducing efficacy, when amino acid was treated alone (Group 3 to Group 6) and a combination of amino acids were treated (Group 7 to Group 12), compared to the fluensulfone-treated Group 2.

As the result of performing phytotoxicity evaluation shown in the SBCPD scale of FIG. 8, it was confirmed that the SBCPD scale of Group 3 to Group 6 that fluensulfone and single amino acid were treated, were decreased compared to the fluensulfone-treated Group 2. Group 7 to Group 12 that fluensulfone with combinations of amino acids were treated, have reduced or similar tendency of the SBCPD scale.

From the above description, those skilled in the art to which the present invention pertains will understand that the present invention may be conducted in other specific forms without changing the technical spirit or essential characteristics thereof. In this regard, it should be understood that the examples described above are illustrative and not restrictive in all respects. The scope of the present invention should be construed as all changed or modified forms derived from the meaning and scope of the present invention and equivalents thereof rather than the above detailed description are included in the scope of the present invention.

1-21. (canceled)

22. A method for reducing phytotoxicity by a pesticide in a subject in need thereof,
comprising administering a composition comprising at least one amino acid selected from the group consisting of histidine, glutamic acid, valine and leucine or a salt thereof as an active ingredient to the subject.

23. The method according to claim 22, wherein the amino acid is a combination of histidine and glutamic acid, a combination of histidine and leucine, a combination of histidine and valine, a combination of glutamic acid and leucine, a combination of glutamic acid and valine, or a combination of leucine and valine.

24. The method according to claim 23, wherein a combination ratio of the amino acid is 1:9 to 9:1 on a weight basis.

25. The method according to claim 22, wherein a concentration of the amino acid in the composition is 0.001 to 1% (w/v).

26. The method according to claim 22, wherein the pesticide comprises a nematicide.

27. The method according to claim 22, wherein the pesticide comprises at least one pesticide selected from the group consisting of aldoxycarb, fosthietan, oxamyl, fenamiphos, fosthiazate, fluensulfone, ethoprophos, dazomet, carbosulfan, cadusafos, methyl bromide, benfuracarb, and abamectin.

28. The method according to claim 22, wherein the subject is any one plant selected from the group consisting of plant of genus Glycine, plant of Genus Arachis, plant of Genus Zea, plant of genus Saccharum, plant of genus Triticum, plant of genus Sorghum, plant of genus Gossypium, plant of genus Solanum, plant of genus Coffea, plant of genus Allium, and plant of genus Vitis.

29. A method for cultivating a plant, comprising administering a composition comprising at least one amino acid selected from the group consisting of histidine, glutamic acid, valine and leucine or a salt thereof as an active ingredient to the subject.

30. The method according to claim 29, wherein the amino acid is a combination of histidine and glutamic acid, a combination of histidine and leucine, a combination of histidine and valine, a combination of glutamic acid and leucine, a combination of glutamic acid and valine, or a combination of leucine and valine.

31. The method according to claim 30, wherein a combination ratio of the amino acid is 1:9 to 9:1 on a weight basis.

32. The method according to claim 29, wherein a concentration of the amino acid in the composition is 0.001 to 1% (w/v).

33. The method according to claim 29, wherein the plant is any one plant selected from the group consisting of plant of genus Glycine, plant of Genus Arachis, plant of Genus Zea, plant of genus Saccharum, plant of genus Triticum, plant of genus Sorghum, plant of genus Gossypium, plant of genus Solanum, plant of genus Coffea, plant of genus Allium, and plant of genus Vitis.

34. The method according to claim 29, wherein the method reduces phytotoxicity by a pesticide.

35. A pesticide composition, comprising at least one amino acid selected from the group consisting of histidine, glutamic acid, valine and leucine or a salt thereof; and a pesticide.

36. The pesticide composition according to claim 35,
wherein the amino acid is a combination of histidine and glutamic acid, a combination of histidine and leucine, a combination of histidine and valine, a combination of glutamic acid and leucine, a combination of glutamic acid and valine, or a combination of leucine and valine.

37. The pesticide composition according to claim 36,
wherein a combination ratio of the amino acid is 1:9 to 9:1 on a weight basis.

38. The pesticide composition according to claim 35,
wherein the amino acid comprised in the pesticide composition is 0.001 to 100 times, based on the weight of the pesticide in the pesticide composition.

39. The pesticide composition according to claim 35,
wherein the pesticide comprises a nematicide.

40. The pesticide composition according to claim 35,
wherein the pesticide comprises at least one pesticide selected from the group consisting of aldoxycarb, fosthietan, oxamyl, fenamiphos, fosthiazate, fluensulfone, ethoprophos, dazomet, carbosulfan, cadusafos, methyl bromide, benfuracarb, and abamectin.
